(19) United States
(12) Patent Application Publication
(10) Pub. No.: US 2010/0219643 A1
(43) Pub. Date: Sep. 2, 2010

(54) VERTICAL-AXIS WIND-POWERED ELECTRIC POWER GENERATOR WITH PHOTOVOLTAIC COGENERATION

(75) Inventors: Sergio Biucchi, Tradate (IT); Marco Mantovani, Vacallo (CH)

Correspondence Address: GIFFORD, KRASS, SPRINKLE,ANDERSON & CITKOWSKI, P.C, PO BOX 7021, TROY, MI, 48007-7021, US

(73) Assignee: WD Ltd., Victoria, MAHE (SC)

(21) Appl. No.: 12/681,942

(22) PCT Filed: Jun. 4, 2008
(86) PCT No.: PCT/IB08/01428

§ 371 Date: Apr. 7, 2010

(30) Foreign Application Priority Data
Oct. 8, 2007 (IT) VA2007-A000075

(51) Int. Cl. F03D 9/00; F03D 3/04

(52) U.S. Cl. 290/55

(57) ABSTRACT

A vertical-axis wind-powered system with photovoltaic cogeneration, for generating electric power, comprising a vertical-axis helical rotor 1 and a system of fixed or moveable statoric shrouds 2 that direct wind onto the rotor while increasing its speed of impact with the rotor 1 in order to enhance the efficiency of the wind-powered generator and enable it to operate even when wind conditions are particularly unfavourable.

### FIELD OF THE INVENTION

The present invention relates to a vertical-axis wind-powered electric power generator with photovoltaic cogeneration.

### STATE OF THE ART

Vertical-axis wind-powered generators are generators of small and medium size which have become popular because of their high efficiency and their flexibility in terms of the wind speeds they can handle.

In fact, they can handle wind speeds of up to 200 km/hr without problem. Furthermore, unlike horizontal-axis generators, they need not be pointed into the wind, which can thus arrive from any direction to turn the rotor.

Among the various configurations, one particularly recalls the Darrieus rotor consisting of a pair of flattened, elongated elements that are connected to form a sort of ellipse whose focal points are along a vertical axis which is integral with the rotor of an electric power generator.

Another configuration comprises a rotor made up of two or more flat rectangular surfaces lying side-by-side-along one of their sides and twisted around said side (DE60315367T, GB1518151 and FI823501) to form a helical rotor.

The quantity of air striking the rotor is proportional to its active surface, so it is particularly difficult for weak winds to initiate rotation despite all possible measures taken to reduce friction.

Furthermore, the fact that the quantity of air striking the rotor is proportional to its active surface negatively affects the efficiency of the generator.

### SUMMARY OF THE INVENTION

The object of the present invention is to provide a vertical-axis wind-powered electric power generator with photovoltaic cogeneration, whose purpose is to overcome said drawback.

The subject of the present invention is a wind-powered system of electric power generation according to claim 1.

According to another aspect of the invention, said device is set up to be partially disassembled and then packed into a standard container for transport to the installation site. Furthermore, the invention comprises special structural features and a kit of equipment that enable the invention to be assembled without the aid of external equipment.

The device can advantageously comprise means of photovoltaic cogeneration of electrical power.

The dependent claims describe the preferred embodiments of the invention and form an integral part of the present description.

### BRIEF DESCRIPTION OF THE DRAWINGS

Additional characteristics and advantages of the invention will become more apparent from a detailed description of a preferred but not exclusive embodiment of the vertical-axis wind-powered electric power generator. Said description, which is provided merely by way of example and without restricting the scope of the inventive concept, is aided by the attached tables of drawings, in which:

FIG. 1 is a frontal view of a vertical-axis-wind-powered generator according to the present invention;

FIG. 2 is a three-dimensional view of a horizontal cross-section of the preceding figure;

FIG. 3 shows a system of swivelling shrouds;

FIG. 4 shows the wind-powered generator without several of its components such as the swivelling shrouds, and the upper and lower balustrades;

FIG. 5 is a transverse cross-section of the wind-powered generator with fixed shrouds;

FIG. 6 is a top plan view of the previous cross-section;

FIGS. 7a, 7b and 7c constitute an example of how the disassembled generator is packed into a standard container;

FIGS. 8a through 8g show the series of steps involved in the assembly of the wind-powered generator;

FIG. 9 is a dimensioned drawing of the wind-powered generator shown in FIG. 5.

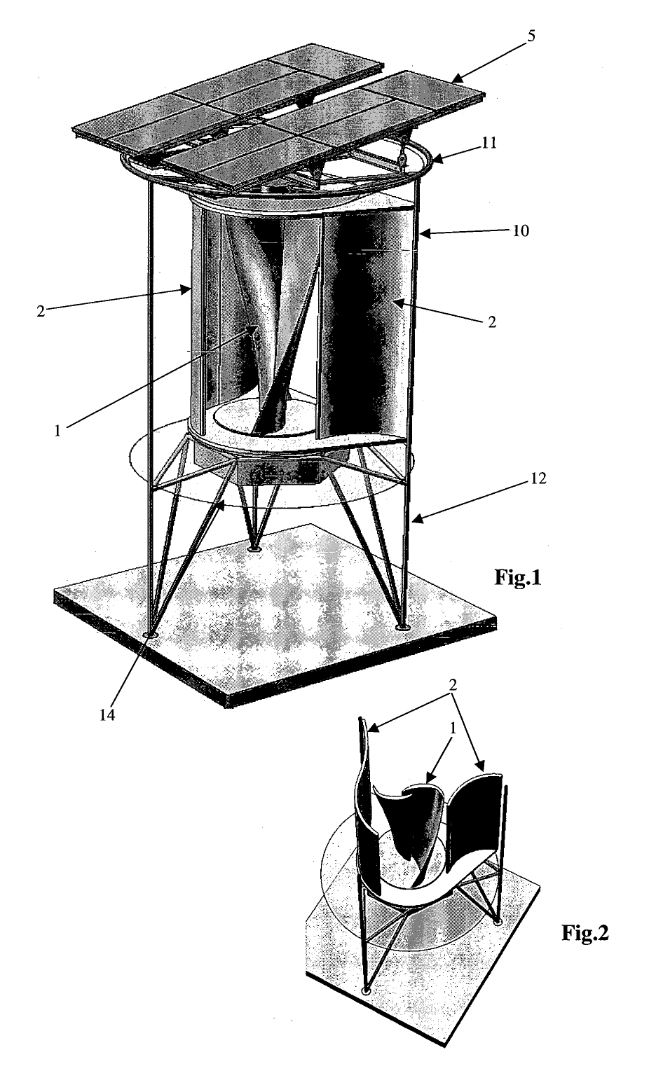

Like elements in the above drawings have the same reference numerals.

### DETAILED DESCRIPTION OF A PREFERRED EMBODIMENT OF THE INVENTION

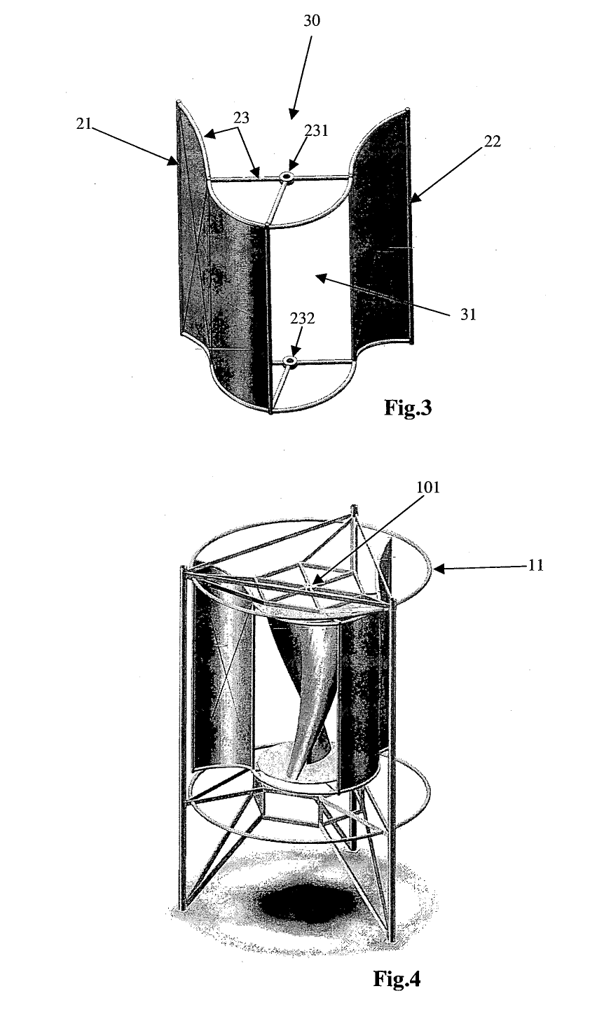

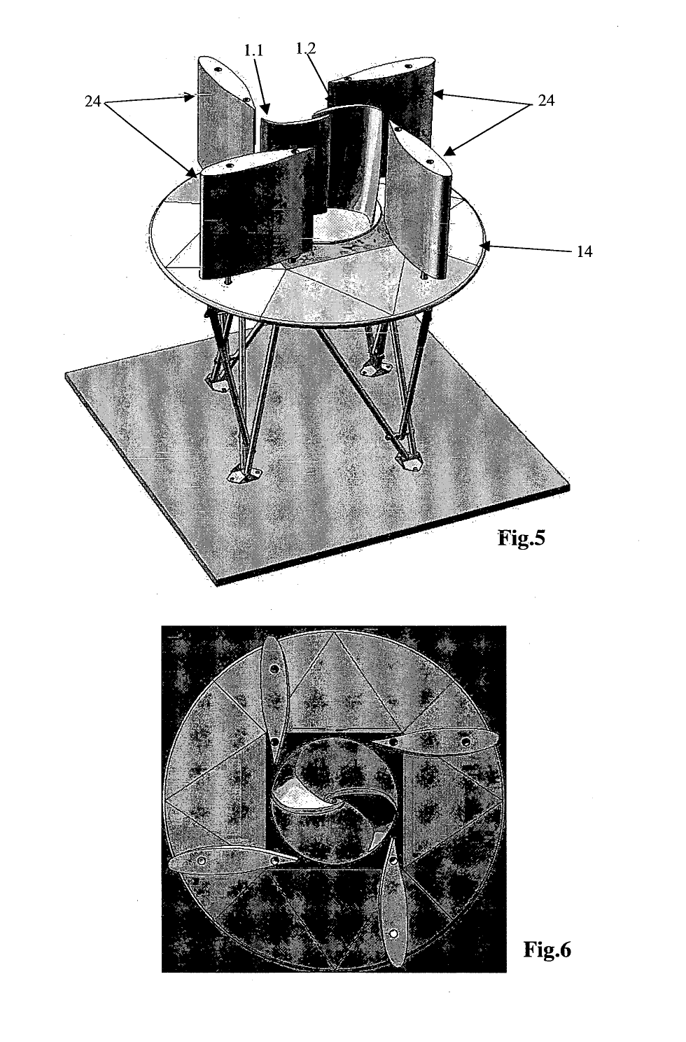

A generator according to the present invention, comprising a helical rotor 1 and a system of statoric shrouds 2 which in a possible variation are fixed 24 (FIG. 5) and in another possible variation can move 21 and 22 (FIG. 3).

The purpose of said system of statoric shrouds is to increase the speed of the air striking the helical rotor.

The system of shrouds, rotor, electric power generator, and all other parts that will be described below are supported by a frame 10.

Besides being connected by a suitable joint to the axis of the electric power generator, the vertical axis of the helical rotor 1 is held in the vertical position by frame 10 employing suitable bushings and/or bearings 101 placed both above and below the helicoid.

An illustrative and not restricted example of an embodiment of the helical rotor 1 comprises two wings 1.1 and 1.2 that at least partially face each other and which twist around each other in a mutually opposing manner to form a spiral in the vertical direction, thus creating a conformation that is substantially of the overturned Bennesh type with a 90° angle of offset between the lower and upper discs.

Said system of shrouds, shown in FIGS. 3 and 4, comprises two shrouds 21 and 22 that are connected to each other by means of a framework 23. Said framework allows the system of shrouds 2 to rotate around the axis of the rotor, and thus to point opening 30, which is defined by the shrouds, into the wind. The shrouds also form an opening 31 through which flows the air that is directed onto the rotor.

To enable the system of shrouds to rotate into the wind, said framework comprises a pair of bushings 231 and 232 which are compatible to the axis of the rotor, so that it can pass through them.

Shroud 21 is shaped in such a way that one of its transverse cross-sections, as shown in FIG. 2, presents a convex shape to the air entering through opening 30. However, after a reverse curve, the concavity reverses and follows the shape of a portion of the cylindrical surface that encloses helicoid 1. The shroud 22 presents the same convexity as shroud 21, but unlike the latter does not have a section of reversed concavity and thus creates opening 31 mentioned above.

The system of shrouds 2 can be moved either through mechanical means or automatically using a vane.

In another preferred embodiment of the invention, said system of shrouds is fixed and, as shown in FIGS. 5 and 6, comprises four shrouds 24 that are arranged tangentially with respect to a cylindrical surface which encloses the rotor and are offset along said cylindrical surface at the same angle with respect to one another. If four shrouds are used, the angle of offset is a right angle; otherwise, the angle is calculated using the formula 360/N°, where N is the number of shrouds.

In this preferred embodiment of the invention, the shrouds 2 oriented in this way are able to direct the wind onto the rotor regardless of its direction and are shaped into an airfoil to increase the speed of the air striking the rotor.

The upper part of frame 10 is flat and forms an upper balustrade 11, which comprises possible walkways and on which one or more photovoltaic panels for cogeneration of electric power are preferably mounted. In this way, electric power can be generated not only simultaneously together with wind generation, but also when there is insufficient wind.

The frame 10 forms a tripod or quadruped at the bottom to raise the rotor and thus take better advantage of the wind.

A lower balustrade is located above the feet 12 formed by frame 10.

Both the helicoid comprising the rotor and the shrouds comprising the shroud system can be made of sturdy, light materials such as aluminium, carbon fibre and/or composite materials.

According to another aspect of the invention, said frame is designed to serve a dual purpose:
to allow simple, rapid assembly without the need for external cranes;
to allow highly compact packaging of the components, in order to take maximum advantage of the internal dimensions of a standard container.

In this regard, it is worth pointing out that the efficiency of a generation system increases with the size of the generator. Thus, the conception of a generator that optimizes space inside a container is anything but trivial.

For this reason, and with particular reference to FIG. 9, it is preferred that the helical rotor have a height of between 2.5 metres and 3.5 metres, and a diameter of between 1.0 and 2.0 metres. The optimum values are 3.0 metres and 1.5 metres, respectively.

The upper 11 and lower 14 balustrades have a preferable, but not essential, diameter of 3.9 metres. The diameter may vary by several decimetres, and the thickness may be from 40 to 50 centimetres.

In this regard, one can deduce from FIG. 9 that the profile of the balustrades is not flat, but is contoured and thickens toward the centre in order to help direct the flow of air onto the rotor.

The feet 12 of frame 10 preferably have a height of 1.8 metres.

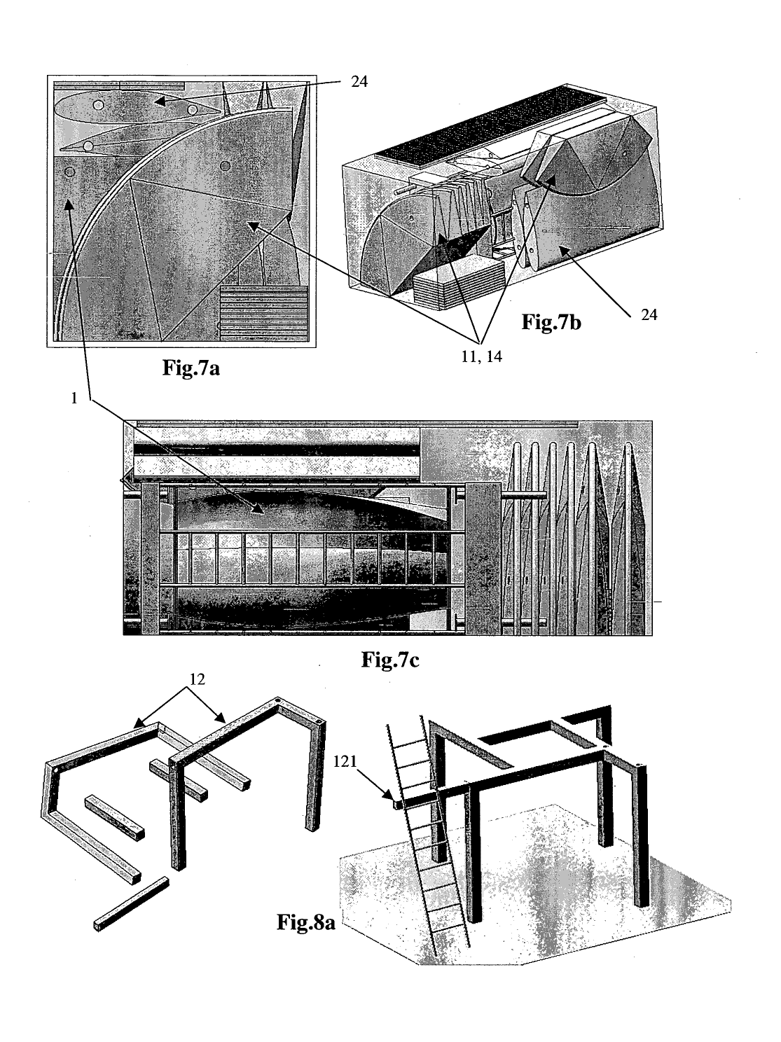

As can be seen in FIGS. 7a, 7b and 7c, a wind-powered generator conforming to the present invention can easily be packed into a standard container. It can also be seen that the lower and upper balustrades are formed by at least four parts each, so they can be easily packed, but that the rotor is preassembled.

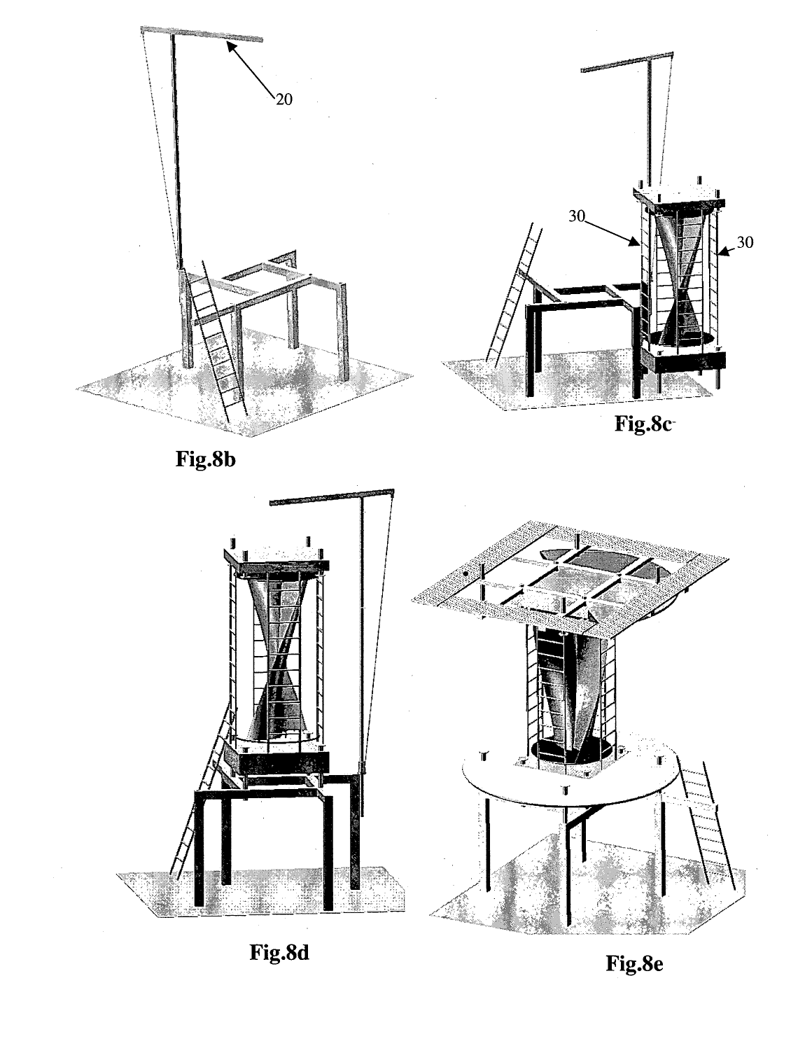

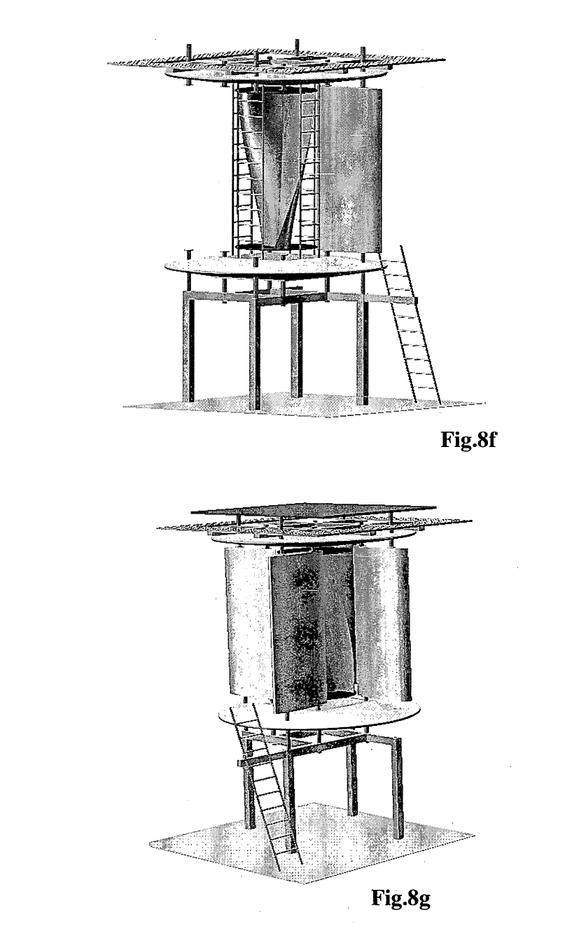

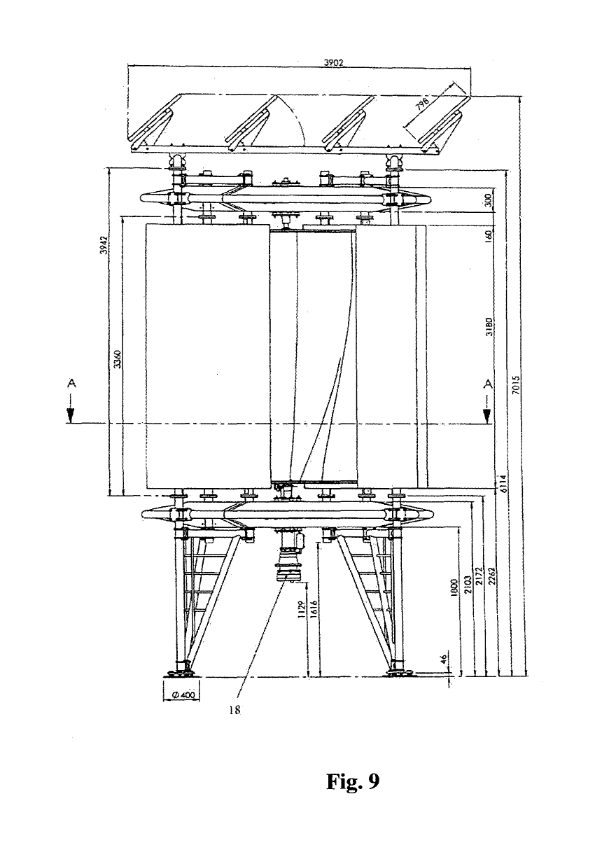

Assembly is performed, according to FIGS. 8a to 8g, by first fitting together the feet 12 of frame 10. Said feet are formed by an equal number of elements that are shaped like a simple frame with an L-shaped crosspiece. Of these elements, at least one includes an extension 121 for placement of a small ladder which is useful while performing assembly and maintenance operations on the generator. Furthermore, another of said frame-shaped elements is set up to support a small crane 20 that to lift the preassembled rotor and place it onto the scaffold formed by said frame-shaped elements. Next, the lower balustrade 14 is mounted, followed by the upper balustrade 11.

After the shrouds 24 have been mounted, the packing and support elements 30 can be removed. In this example, the shrouds perform not only an aerodynamic function, but also a structural function since they support the upper part of frame 10, the upper balustrade 11 and the photovoltaic panels 5, if installed.

The above method of transport and assembly can be employed in the same way on the first example of the vertical-axis wind-powered generator in which the shroud system 2 can swivel.

As an additional advantage, the invention packed as described is particularly suited for use in places where no electrical power or lifting equipment such as cranes are available, since the invention can be assembled using the kit included with the packed materials.

The specific methods of construction illustrated herein do not limit the substance of this application, which covers all variations of the invention defined by the claims.

1. A wind-powered system for generating electric power, comprising a vertical-axis helical rotor and a system of statoric shrouds, said system of statoric shrouds being placed around said rotor in a way that increases the speed of the air striking the helical rotor.

2. A system according to claim 1, wherein it includes a means of photovoltaic cogeneration of electric power.

3. A system according to claim 1, wherein said helical rotor comprises two wings that at least partially face each other and which twist around each other in a mutually opposing manner to form a spiral in the vertical direction and thus create a conformation that is substantially of the overturned Bennesh type.

4. A system according to claim 3, wherein said statoric shrouds rotate together with the rotor and can swivel according to the wind direction.

5. A system according to claim 4, wherein said system of statoric shrouds of a swiveling type comprises a first and a second shroud connected to each other by a framework, and a first and second opening between the shrouds, said framework allowing said system of shrouds to rotate around the axis of said helical rotor in order to trim said first opening according to the wind, thus allowing air to enter and then pass through said second opening, thus directing the conveyed air onto the rotor.

6. A system according to claim 5, wherein said first shroud is shaped in such a way that a first part of its transverse cross-section presents a convex shape to the air entering through said first opening, but its concavity reverses after an inflexion in a second part and follows the shape of a portion of the cylindrical surface enclosing said helical rotor, said second shroud presenting the same convexity as the first part of said first shroud.

7. A system according to claim 3, wherein said system of statoric shrouds is fixed.

8. A system according to claim 7, wherein said fixed system of statoric shrouds comprises shrouds that are arranged tangentially with respect to a cylindrical surface which encloses the rotor and are offset along said cylindrical surface at the same angle with respect to each other, said shrouds being able to direct wind onto said helical rotor regardless of its direction and having the shape of an airfoil.

9. A system according to claim 8, wherein said fixed shrouds are four and offset from one another at an angle of 90°.

10. A system according to claim 1, wherein said means of photovoltaic generation of electric power are positioned above said means of wind-powered generation.

11. A system according to claim 1, wherein it is particularly suited to being transported in a standard container, comprising a frame that can be separated into at least three feet and into a lower and an upper balustrades that can each be disassembled into at least two parts.

12. A system according to claim 7, wherein the statoric shrouds form an integral part of the frame that supports the upper balustrade.

13. A system according to claim 11, particularly suited to being transported in a standard container and wherein:
the helical rotor has a height of 2.5 to 3.5 metres, with the optimum value being 3.0 metres;
the helical rotor has a diameter of 1.0 to 2.0 metres, with the optimum value being 1.5 metres;
the upper balustrade and lower balustrade have a thickness of approximately 40 to 50 centimetres and a diameter of 3.4 to 4.5 metres, with the preferred value being 3.9 metres;
the feet supporting the frame preferably have a height of 1.8 metres.
